(19) United States
(12) Patent Application Publication
(10) Pub. No.: US 2026/0350069 A1
(43) Pub. Date: Nov. 5, 2026

(54) Systems and Methods for Enabling Visibility in Online Environments

(71) Applicant: ServiceNow, Inc., Santa Clara, CA (US)

(72) Inventors: Barel Mengel, Petah Tikva (IL); Ofir Kapustian, Ramat-Gan (IL); Yair Aharon Leibkowiz, Kiryat Malachi (IL); Robert Bitterfeld, Petah Tikva (IL)

(21) Appl. No.: 19/196,163

(22) Filed: May 1, 2025

(51) Int. Cl. G06F 16/334; G06F 40/30

(52) U.S. Cl. CPC G06F 16/334; G06F 40/30

(57) ABSTRACT

A method may include filtering a plurality of software processes into a plurality of application service candidates. The method may also include receiving a user query related to an online environment and identifying a particular application service candidate of the plurality of service candidates based on a semantic comparison of the query to each respective description of the plurality of application service candidates. The method may further include providing a predicted name and description of the particular application service candidate.

### TECHNICAL FIELD

The present disclosure relates generally to systems and methods for identifying the application services that are present in an online environment and using machine learning tools to generate useful information about the application services.

### BACKGROUND

This section is intended to introduce the reader to various aspects of art that may be related to various aspects of the present disclosure, which are described and/or claimed below. This discussion is believed to be helpful in providing the reader with background information to facilitate a better understanding of the various aspects of the present disclosure. Accordingly, it should be understood that these statements are to be read in this light, and not as admissions of prior art.

Interactive online systems (“online environments”) often include many application services. Application services are software solutions that may improve an online environment and facilitate enterprise operations. Application services may, for example, provide software-as-a-service (SaaS) solutions, data mining and monitoring techniques, and the like. Online environments may include a mix of legacy application services and current or in-production application services that contribute to the operation of the online environment. As online environments grow, encounter technical problems, or take advantage of new technical solutions, additional application services may be deployed. As a result, it may be difficult to keep track of the application services. For example, as dozens or hundreds of application services are included in an online environment, some of the application services may be forgotten about or be difficult to track as they may become intertwined with or superseded by other application services. Difficulty in identifying and tracking application services may be a source of technical constraints, poor utilization of computing resources, and business inefficiencies.

### SUMMARY

A summary of certain embodiments disclosed herein is set forth below. It should be understood that these aspects are presented merely to provide the reader with a brief summary of these certain embodiments and that these aspects are not intended to limit the scope of this disclosure. Indeed, this disclosure may encompass a variety of aspects that may not be set forth below.

In an embodiment, a method may include filtering a plurality of software processes into a plurality of application service candidates. Filtering the software processes may include receiving a plurality of application fingerprints, where the plurality of application fingerprints are generated based on data associated with the plurality of software processes in an online environment. Filtering the software processes may also include associating one or more of the plurality of application fingerprints with one or more respective application service candidates of the plurality of application service candidates. Filtering the software processes may further include generating, via a pretrained model, based on the one or more application fingerprints, a predicted name and description for each of the plurality of application service candidates. The method may also include receiving a user query related to an online environment and identifying a particular application service candidate of the plurality of service candidates based on a semantic comparison of the query to each respective description of the plurality of application service candidates. The method may further include providing the predicted name and description of the particular application service candidate.

In another embodiment, a system may include processing circuity and memory that is accessible by the processing circuity. The memory stores instructions that, when executed by the processing circuitry, cause the processing circuity to perform operations. These operations may include filtering a plurality of software processes into a plurality of application service candidates. Filtering the software processes may include receiving a plurality of application fingerprints, where the plurality of application fingerprints are generated based on data associated with the plurality of software processes in an online environment. Filtering the software processes may also include associating one or more of the plurality of application fingerprints with one or more respective application service candidates of the plurality of application service candidates. Filtering the software processes may further include generating, via a pretrained model, based on the one or more application fingerprints, a predicted name and description for each of the plurality of application service candidates. The operations may also include receiving a user query related to an online environment and identifying a particular application service candidate of the plurality of service candidates based on a semantic comparison of the query to each respective description of the plurality of application service candidates. The operations may further include providing the predicted name and description of the particular application service candidate.

In a further embodiment, a non-transitory, computer readable medium includes instructions that, when executed by processing circuity, cause the processing circuitry to perform operations. These operations may include filtering a plurality of software processes into a plurality of application service candidates. Filtering the software processes may include receiving a plurality of application fingerprints, where the plurality of application fingerprints are generated based on data associated with the plurality of software processes in an online environment. Filtering the software processes may also include associating one or more of the plurality of application fingerprints with one or more respective application service candidates of the plurality of application service candidates. Filtering the software processes may further include generating, via a pretrained model, based on the one or more application fingerprints, a predicted name and description for each of the plurality of application service candidates. The operations may also include receiving a user query related to an online environment and identifying a particular application service candidate of the plurality of service candidates based on a semantic comparison of the query to each respective description of the plurality of application service candidates. The operations may further include providing the predicted name and description of the particular application service candidate.

Various refinements of the features noted above may exist in relation to various aspects of the present disclosure. Further features may also be incorporated in these various aspects as well. These refinements and additional features may exist individually or in any combination. For instance, various features discussed below in relation to one or more of the illustrated embodiments may be incorporated into any of the above-described aspects of the present disclosure alone or in any combination. The brief summary presented above is intended only to familiarize the reader with certain aspects and contexts of embodiments of the present disclosure without limitation to the claimed subject matter.

### BRIEF DESCRIPTION OF THE DRAWINGS

Various aspects of this disclosure may be better understood upon reading the following detailed description and upon reference to the drawings in which:

FIG. 1 is a block diagram of an embodiment of a multi-instance cloud architecture in which embodiments of the present disclosure may operate;

FIG. 2 is a schematic of an embodiment of a multi-instance cloud architecture in which embodiments of the present disclosure may operate;

FIG. 3 is a block diagram of a computing device utilized in a computing system that may be present in FIG. 1 or 2, in accordance with aspects of the present disclosure;

FIG. 4 is a block diagram illustrating a virtual server that supports and enables a client instance configured to manage a database and an application identification model configured to identify application services in an online environment, in accordance with aspects of the present disclosure;

FIG. 5 is an example of a graphical user interface (GUI) for providing artificial intelligence-based responses to client inquiries about the application services in the online environment identified by the application identification model of FIG. 4, in accordance with aspects of the present disclosure;

FIG. 6 is an example of a GUI depicting information that the application identification model of FIG. 4 may generate regarding an application service candidate, in accordance with aspects of the present disclosure;

FIG. 7 is an example of a GUI depicting information that the application identification model of FIG. 4 may generate regarding application fingerprints, in accordance with aspects of the present disclosure;

FIG. 8 is a flow diagram depicting a preprocessing technique for generating information about the application service candidates in the online environment via the application identification model of FIG. 4, in accordance with aspects of the present disclosure;

FIG. 9 is a flow diagram depicting a preprocessing technique for identifying application fingerprints via the application identification model of FIG. 4, in accordance with aspects of the present disclosure;

FIG. 10 is a flow chart illustrating a process of generating information about the application service candidates and using that information in conjunction with a virtual assistant, in accordance with aspects of the present disclosure; and

FIG. 11 is a flow chart illustrating a process of filtering software processes, in accordance with aspects of the present disclosure.

### DETAILED DESCRIPTION

One or more specific embodiments will be described below. In an effort to provide a concise description of these embodiments, not all features of an actual implementation are described in the specification. It should be appreciated that in the development of any such actual implementation, as in any engineering or design project, numerous implementation-specific decisions must be made to achieve the developers'specific goals, such as compliance with system-related and enterprise-related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure.

As online environments grow and become more complex, it may be increasingly difficult to track and map the application services that are running in the online environment. In many online environments, application services may serve important business functions without being adequately identifiable (e.g., named) or understandable (e.g., sufficiently described). Moreover, difficulty tracking application services may be exasperated by the assistance of artificial intelligence and machine learning technologies. Machine learning algorithms, for example, may recommend incorporating certain application services into an online environment. In some cases, the machine learning algorithms may automatically select and deploy application services. Thus, application services may be added to the online environments without user selection and active incorporation into the online environments. Consequently, machine learning algorithms for selecting and deploying application services may reduce the ability to identify and track application services in the online environment.

As mentioned above, difficulty identifying and tracking application services may be a source of technical constraints, poor utilization of computing resources, and business inefficiencies. For example, it may be difficult to retroactively map unidentifiable and undescribed application services in organizational structures, such as enterprise architecture or application dependency maps, which provide insights into the online environment. It may, therefore, be difficult to determine how application services will be impacted by changes to the online environment. Likewise, it may be difficult to review and debug an online environment without knowing which application services are acting in the online environment or understanding the functions of those application services within the online environment. It is recognized that systems and methods for identifying and describing application services in online environments provide beneficial visibility into the online environments.

With the foregoing in mind, the present disclosure generally relates to providing visibility into an online environment. More specifically, the present disclosure relates to identifying the application services that are present in an online environment, and using machine learning tools to generate useful information about the application services. In a preprocessing step, a pretrained model (e.g., a large language model (LLM)) may receive data from the online environment and automatically classify and categorize the data to determine application identifiers or indicators (e.g., “fingerprints”). By way of example, in certain implementations application fingerprints may be clusters of processes that are running in the online environment. The pretrained model may extract information (e.g., names, descriptions, publishers, and keywords) for each application fingerprint in the online environment. The pretrained model may query a list of the application services that may be incorporated into a specific online environment (“application service candidates”), and map the application fingerprints to the application service candidates. The pretrained model may use the descriptions of the associated application fingerprints to generate information associated with each application service candidate, such as an application service candidate name, a publisher of the application service candidate, a plain language description of the application service candidate, one or more key word identifiers of the application service candidate, or the like.

In an embodiment, the preprocessing technique for identifying the application service candidates may be used in conjunction with user-facing artificial intelligence technology. For example, the preprocessing technique described herein may be used with an artificial intelligence assistant, such as a text-based or voice-based chat bot that may be trained to respond to user inquiries about the online environment. The user may query the artificial intelligence assistant with a question about the online environment (e.g., a question about the application service for a specific function of the online environment), and in response the artificial intelligence assistant may generate and return information (e.g., the predicted names, plain language descriptions) about the relevant application services candidates in the online environment. The user may select one or more of the application service candidates provided by the artificial intelligence assistant as identified application services in the online environment. The application services that are identified by the user selection may be added to an organizational map or structure associated with the online environment. Because of the preprocessing step, which may be performed offline in a batch processing mode, the artificial intelligent assistant may be able to provide temporally efficient results (e.g., real-time results). Similarly, the techniques disclosed herein may provide advantages in the way of more efficient use of the computational resources (e.g., processing and memory resources) that may be used to respond to user inquiries about the application services in the online environment.

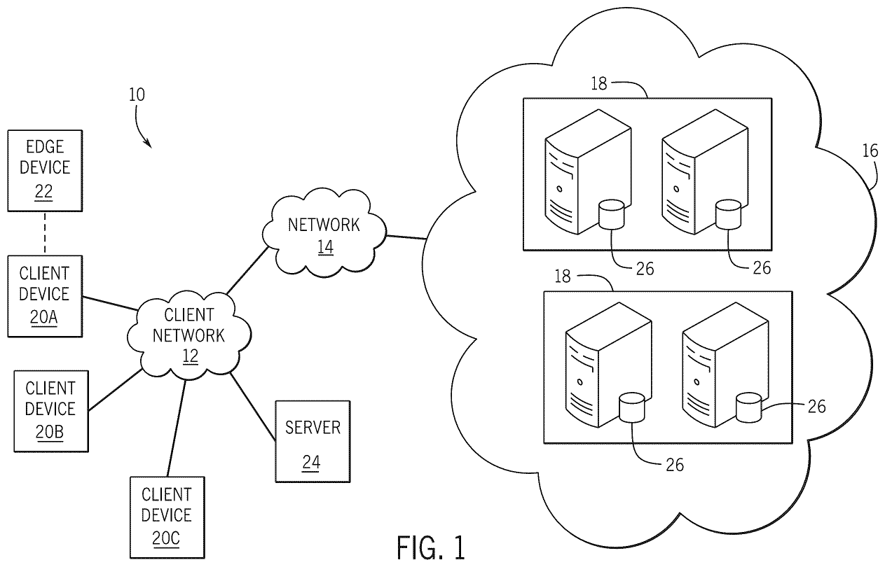

With the preceding in mind, the following figures relate to various types of generalized system architectures or configurations that may be employed to provide services to an organization for which the present approaches may be employed. Correspondingly, these system and platform examples may also relate to systems and platforms on which the techniques discussed herein may be implemented or otherwise utilized. Turning now to FIG. 1, a schematic diagram of an embodiment of a cloud computing system 10 where embodiments of the present disclosure may operate, is illustrated. The cloud computing system 10 may include a client network 12, a network 14 (e.g., the Internet), and a cloud-based platform 16. In one embodiment, the client network 12 may be a local private network, such as local area network (LAN) having a variety of network devices that include, but are not limited to, switches, servers, and routers. In another embodiment, the client network 12 represents an enterprise network that could include one or more LANs, virtual networks, data centers 18, and/or other remote networks. As shown in FIG. 1, the client network 12 is able to connect to one or more client devices 20A, 20B, and 20C so that the client devices are able to communicate with each other and/or with the network hosting the platform 16. The client devices 20A, 20B, 20C may be computing systems and/or other types of computing devices that access cloud computing services, for example, via a web browser application or via an edge device 22 that may act as a gateway between the client devices 20A, 20B, 20C and the platform 16. FIG. 1 also illustrates that the client network 12 includes an administration or managerial application, device, agent, or server, such as a server 24 that facilitates communication of data between the network hosting the platform 16, other external applications, data sources, and services, and the client network 12. Although not specifically illustrated in FIG. 1, the client network 12 may also include a connecting network device (e.g., a gateway or router) or a combination of devices that implement a customer firewall or intrusion protection system.

For the illustrated embodiment, FIG. 1 illustrates that client network 12 is coupled to the network 14, which may include one or more computing networks, such as other LANs, wide area networks (WAN), the Internet, and/or other remote networks, to transfer data between the client devices 20A, 20B, 20C and the network hosting the platform 16. Each of the computing networks within network 14 may contain wired and/or wireless programmable devices that operate in the electrical and/or optical domain. For example, network 14 may include wireless networks, such as cellular networks (e.g., Global System for Mobile Communications (GSM) based cellular network), IEEE 802.11 networks, and/or other suitable radio-based networks. The network 14 may also employ any number of network communication protocols, such as Transmission Control Protocol (TCP) and Internet Protocol (IP). Although not explicitly shown in FIG. 1, network 14 may include a variety of network devices, such as servers, routers, network switches, and/or other network hardware devices configured to transport data over the network 14.

In FIG. 1, the network hosting the platform 16 may be a remote network (e.g., a cloud network) that is able to communicate with the client devices 20A, 20B, 20C via the client network 12 and network 14. The network hosting the platform 16 provides additional computing resources to the client devices 20A, 20B, 20C and/or the client network 12. For example, by utilizing the network hosting the platform 16, users of the client devices 20A, 20B, 20C are able to build and execute applications and/or workflows for various enterprise, IT, and/or other organization-related functions. In one embodiment, the network hosting the platform 16 is implemented on the one or more data centers 18, where each data center could correspond to a different geographic location. Each of the data centers 18 includes a plurality of virtual servers 26 (also referred to herein as application nodes, application servers, virtual server instances, application instances, or application server instances), where each virtual server 26 can be implemented on a physical computing system, such as a single electronic computing device (e.g., a single physical hardware server) or across multiple-computing devices (e.g., multiple physical hardware servers). Examples of virtual servers 26 include, but are not limited to a web server (e.g., a unitary Apache installation), an application server (e.g., unitary JAVA Virtual Machine), and/or a database server (e.g., a unitary relational database management system (RDBMS) catalog).

To utilize computing resources within the platform 16, network operators may choose to configure the data centers 18 using a variety of computing infrastructures. In one embodiment, one or more of the data centers 18 are configured using a multi-tenant cloud architecture, such that one of the server instances 26 handles requests from and serves multiple customers. Data centers 18 with multi-tenant cloud architecture commingle and store data from multiple customers, where multiple customer instances are assigned to one of the virtual servers 26. In a multi-tenant cloud architecture, the particular virtual server 26 distinguishes between and segregates data and other information of the various customers. For example, a multi-tenant cloud architecture could assign a particular identifier for each customer in order to identify and segregate the data from each customer. Generally, implementing a multi-tenant cloud architecture may suffer from various drawbacks, such as a failure of a particular one of the server instances 26 causing outages for all customers allocated to the particular server instance.

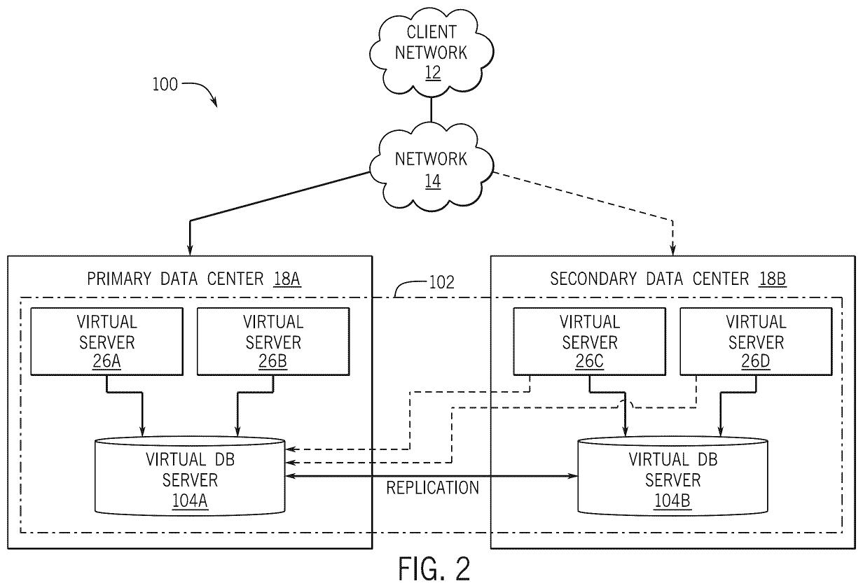

In another embodiment, one or more of the data centers 18 are configured using a multi-instance cloud architecture to provide every customer its own unique customer instance or instances. For example, a multi-instance cloud architecture could provide each customer instance with its own dedicated application server(s) and dedicated database server(s). In other examples, the multi-instance cloud architecture could deploy a single physical or virtual server 26 and/or other combinations of physical and/or virtual servers 26, such as one or more dedicated web servers, one or more dedicated application servers, and one or more database servers, for each customer instance. In a multi-instance cloud architecture, multiple customer instances could be installed on one or more respective hardware servers, where each customer instance is allocated certain portions of the physical server resources, such as computing memory, storage, and processing power. By doing so, each customer instance has its own unique software stack that provides the benefit of data isolation, relatively less downtime for customers to access the platform 16, and customer-driven upgrade schedules. An example of implementing a customer instance within a multi-instance cloud architecture will be discussed in more detail below with reference to FIG. 2.

FIG. 2 is a schematic diagram of an embodiment of a multi-instance cloud architecture 100 where embodiments of the present disclosure may operate. FIG. 2 illustrates that the multi-instance cloud architecture 100 includes the client network 12 and the network 14 that connect to two (e.g., paired) data centers 18A and 18B that may be geographically separated from one another and provide data replication and/or failover capabilities. Using FIG. 2 as an example, network environment and service provider cloud infrastructure client instance 102 (also referred to herein as a client instance 102) is associated with (e.g., supported and enabled by) dedicated virtual servers (e.g., virtual servers 26A, 26B, 26C, and 26D) and dedicated database servers (e.g., virtual database servers 104A and 104B). Stated another way, the virtual servers 26A-26D and virtual database servers 104A and 104B are not shared with other client instances and are specific to the respective client instance 102. In the depicted example, to facilitate availability of the client instance 102, the virtual servers 26A-26D and virtual database servers 104A and 104B are allocated to two different data centers 18A and 18B so that one of the data centers 18 acts as a backup data center. Other embodiments of the multi-instance cloud architecture 100 could include other types of dedicated virtual servers, such as a web server. For example, the client instance 102 could be associated with (e.g., supported and enabled by) the dedicated virtual servers 26A-26D, dedicated virtual database servers 104A and 104B, and additional dedicated virtual web servers (not shown in FIG. 2).

Although FIGS. 1 and 2 illustrate specific embodiments of a cloud computing system 10 and a multi-instance cloud architecture 100, respectively, this disclosure is not limited to the specific embodiments illustrated in FIGS. 1 and 2. For instance, although FIG. 1 illustrates that the platform 16 is implemented using data centers, other embodiments of the platform 16 are not limited to data centers and can utilize other types of remote network infrastructures. Moreover, other embodiments of the present disclosure may combine one or more different virtual servers into a single virtual server or, conversely, perform operations attributed to a single virtual server using multiple virtual servers. For instance, using FIG. 2 as an example, the virtual servers 26A, 26B, 26C, 26D and virtual database servers 104A, 104B may be combined into a single virtual server. Moreover, the present approaches may be implemented in other architectures or configurations, including, but not limited to, multi-tenant architectures, generalized client/server implementations, and/or even on a single physical processor-based device configured to perform some or all of the operations discussed herein. Similarly, though virtual servers or machines may be referenced to facilitate discussion of an implementation, physical servers may instead be employed as appropriate. The use and discussion of FIGS. 1 and 2 are only examples to facilitate ease of description and explanation and are not intended to limit the disclosure to the specific examples illustrated therein.

As may be appreciated, the respective architectures and frameworks discussed with respect to FIGS. 1 and 2 incorporate computing systems of various types (e.g., servers, workstations, client devices, laptops, tablet computers, cellular telephones, edge devices, and so forth) throughout. For the sake of completeness, a brief, high level overview of components typically found in such systems is provided. As may be appreciated, the present overview is intended to merely provide a high-level, generalized view of components typical in such computing systems and should not be viewed as limiting in terms of components discussed or omitted from discussion.

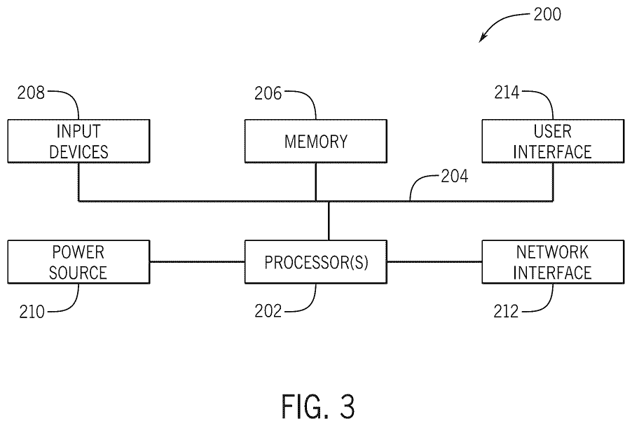

By way of background, it may be appreciated that the present approach may be implemented using one or more processor-based systems such as shown in FIG. 3. Likewise, applications and/or databases utilized in the present approach may be stored, employed, and/or maintained on such processor-based systems. As may be appreciated, such systems as shown in FIG. 3 may be present in a distributed computing environment, a networked environment, or other multi-computer platform or architecture. Likewise, systems such as that shown in FIG. 3, may be used in supporting or communicating with one or more virtual environments or computational instances on which the present approach may be implemented.

With this in mind, an example computing system 200 may include some or all of the computer components depicted in FIG. 3. FIG. 3 generally illustrates a block diagram of example components of a computing system 200 and their potential interconnections or communication paths, such as along one or more busses. As illustrated, the computing system 200 may include various hardware components such as, but not limited to, one or more processors 202 (e.g., processing circuitry), one or more busses 204, memory 206, input devices 208, a power source 210, a network interface 212, a user interface 214, and/or other computer components useful in performing the functions described herein.

The one or more processors 202 may include one or more microprocessors capable of performing instructions stored in the memory 206. Additionally or alternatively, the one or more processors 202 may include application-specific integrated circuits (ASICs), field-programmable gate arrays (FPGAs), and/or other devices designed to perform some or all of the functions discussed herein without calling instructions from the memory 206.

With respect to other components, the one or more busses 204 include suitable electrical channels to provide data and/or power between the various components of the computing system 200. The memory 206 may include any tangible, non-transitory, and computer-readable storage media. Although shown as a single block in FIG. 1, the memory 206 can be implemented using multiple physical units of the same or different types in one or more physical locations. The input devices 208 correspond to structures to input data and/or commands to the one or more processors 202. For example, the input devices 208 may include a mouse, touchpad, touchscreen, keyboard and the like. The power source 210 can be any suitable source for power of the various components of the computing device 200, such as line power and/or a battery source. The network interface 212 includes one or more transceivers capable of communicating with other devices over one or more networks (e.g., a communication channel). The network interface 212 may provide a wired network interface or a wireless network interface. A user interface 214 may include a display that is configured to display text or images transferred to it from the one or more processors 202.

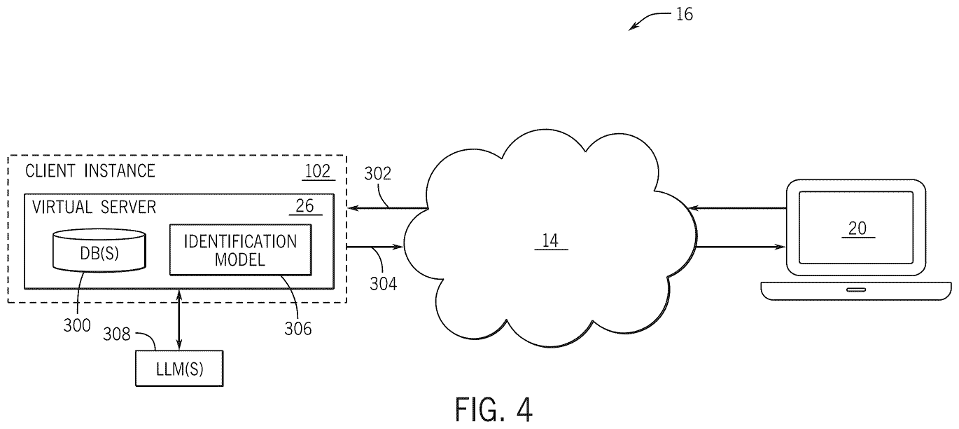

With the preceding in mind, FIG. 4 is a block diagram illustrating an embodiment in which a virtual server 26 supports and enables the client instance 102, according to one or more disclosed embodiments. More specifically, FIG. 4 illustrates an example of a portion of a service provider cloud infrastructure, including the cloud-based platform 16 discussed above. The cloud-based platform 16 is connected to a client device 20 via the network 14 to provide a user interface to network applications executing within the client instance 102 (e.g., via a web browser or a native application running on the client device 20). Client instance 102 is supported by virtual servers 26 similar to those explained with respect to FIG. 2, and is illustrated here to show support for the disclosed functionality described herein within the client instance 102. Cloud provider infrastructures are generally configured to support a plurality of end-user devices, such as client device(s) 20, concurrently, wherein each end-user device is in communication with the single client instance 102. Also, cloud provider infrastructures may be configured to support any number of client instances, such as client instance 102, concurrently, with each of the instances in communication with one or more end-user devices. As mentioned above, an end-user may also interface with the client instance 102 using an application and/or a web browser.

As shown in FIG. 4, virtual server 26 may host or otherwise have access to one or more databases 300, which may include one or more database tables for storing various types of data (e.g., employee data, customer data, vendor data, procurement data, accounting data, asset data, information technology (IT) data, product data, and so forth). The virtual server 26 may receive inputs 302 from the client device 20, which may include, for example, requests for the virtual server 26 to perform various operations on the databases 300. For example, the inputs 302 may include requests to retrieve one or more records from the database 300, modify records stored in the database 300, add records to the database, and so forth. The virtual server 26 may generate outputs 304 to be transmitted back to the client device. The outputs 304 may include, for example, data from records retrieved from the database 300, confirmation that requested operations have been performed, and so forth. In some embodiments, the databases 300 are configured to store encrypted data. In such embodiments the virtual server 26 may use an identification model 306 to identify applications in an online environment. As discussed in more detail herein, the identification model 306 may be one or more pretrained machine learning models or algorithms that may be used to facilitate application services identification. The identification model 306 may utilize one or more large language models 308 (LLMs), which may be accessible to the client instance 102 (as shown in FIG. 4), or stored within the client instance 102, to generate some or all of the outputs 304. As used herein, an LLM is a probabilistic model of a natural language used for general-purpose language generation. LLMs typically include one or more artificial neural networks having a transformer-base architecture. LLMs learn statistical relationships from text documents through training processes that may be supervised, semi-supervised, or self-supervised. During training, LLMs may learn syntax, semantics, and/or ontology. LLMs, when used for text generation, receive an input text (e.g., the inputs 302) and iteratively predict the next word or token. It should be understood that the client instance 102 shown in FIG. 4 may be utilized by the client device 20 for other tasks associated with application service candidate identifications, as well as tasks beyond the scope of application service candidate identification, such as generating responses to queries from the client device 20.

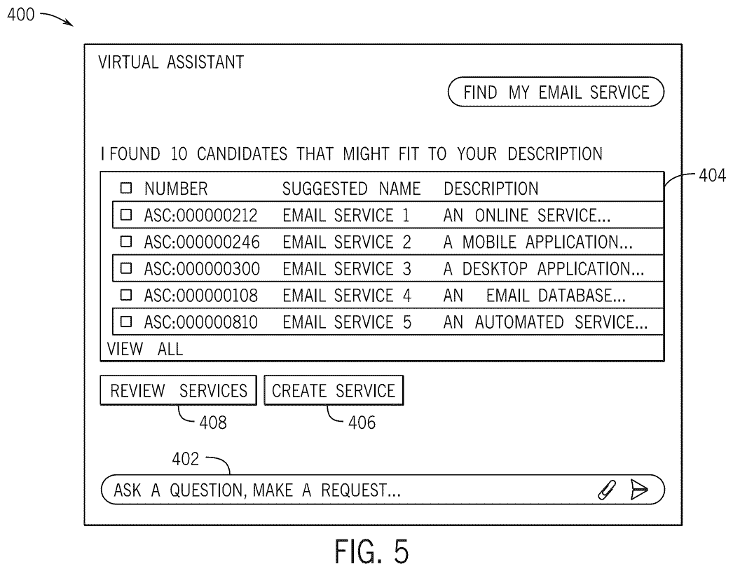

With the preceding in mind, FIG. 5 is an example of a graphical user interface (GUI) 400 for providing artificial intelligence-based responses to client inquiries about the application services in an online environment. More specifically, FIG. 5 is an example of a GUI 400 that contains a virtual assistant 402 that may communicate information regarding application service candidates. The virtual assistant 402 may be an artificial intelligence-based assistant that utilizes artificial intelligence, such as a natural language processing (NLP) models, LLMs (e.g., the LLMs 308 in FIG. 4), neural networks, Retrieval-Augmented Generation (RAG) models, or the like. In some embodiments, the virtual assistant 402 may be part of the identification model 306. The virtual assistant 402 may be text-activated (e.g., a chat bot) or voice-activated. The virtual assistant 402 may respond to a variety of user questions. For example, the virtual assistant 402 may be able to identify by name, description, publisher, and keywords the different application service candidates in an online environment based on plain language requests for information.

In some embodiments, the virtual assistant 402 may provide names and descriptions for the application services candidates that are responsive to a user query. By way of example, in FIG. 5, the virtual assistant 402 has provided a list of application service candidate 404 results related to e-mail services. The list of application service candidates 404 may be responsive to a text query, such as “please show me all the email services my company currently uses,” “find the active email services that we have used in the past month,” or “what services are used to contact customers.” These examples are intended to demonstrate that the virtual assistant 402 may respond to various sentence structures and vocabulary. Although only three query examples are provided, it is envisaged that the virtual assistant 402 may respond to any number of queries pertaining to various services in their online environment.

In some embodiments, the GUI 400 may have additional affordances that may provide additional services associated with the application service identification. For example, the GUI 400 may include a create services affordance 406. In some embodiments, a particular application service candidate may be selected (e.g., from the list of application service candidates 404) as an identified application service. The create services affordance 406 may be used to map application services that are identified in the online environment. For example, when an application service is identified it may be mapped into an enterprise architecture, an application dependency map (e.g., a map showing hierarchical connections between application service candidates), or the like. This may provide the enterprise associated with the online environment with an efficient way to review the application services that are present in the online environment. A review services affordance 408 may be used to view identified application services in the online environment. The review services affordance 408 may, for example, act as a redirect to another GUI window or popup showing a list or mapping of the identified application services in the online environment. In these ways, the GUI 400 may provide tools for identifying names, descriptions, and additional information associated with the application service candidates in the online environment, mapping the identified application services, and reviewing the identified application services.

It should be noted that the virtual assistant 402 may be trained using a wide variety of training data. In embodiments, the virtual assistant 402 may be trained using data from a variety of online environments associated with different enterprises. The virtual assistant 402 may also be refined (e.g., adjusted, reweighted) for a particular online environment. That is, the virtual assistant 402 may be tailored to an enterprise associated with the particular online environment that it is interacting with. In these ways, the virtual assistant 402 may provide a list of application service candidates 404 for the particular online environment.

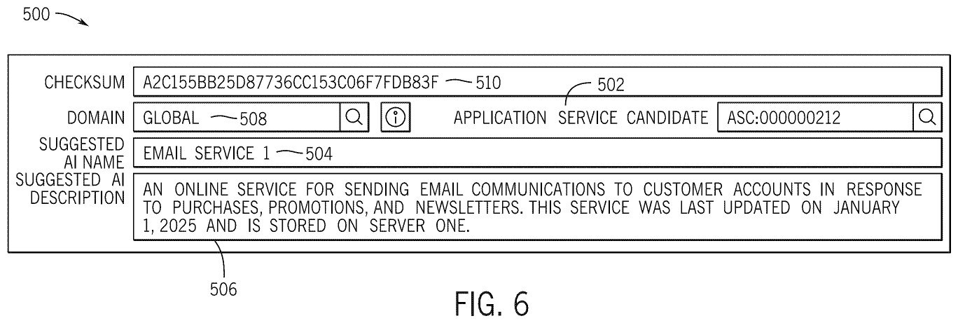

FIG. 6 is an example of a GUI 500 depicting information that the identification model 306 may generate regarding an application service candidate. As mentioned above, a virtual assistant (e.g., virtual assistant 402 in FIG. 5) may identify application services responsive to user queries. To enable efficient searching by the virtual assistant, preprocessing techniques may be used to analyze the application service candidates that may be active in the online environments and identify useful information about the application service candidates. In this way, the GUI 500 may serve as a demonstration of the information associated with the application service candidate that the identification model 306 may extract and generate during preprocessing. Each application service candidate may have a specified candidate number 502. The application service candidate number 502 may be a unique reference number for identifying the application service candidate within the online environment. The identification model 306 may also generate or identify a name 504 for the application service candidates. According to previous techniques, an application service candidate may have been unnamed or may have been labeled with a generic name. For example, the application service candidates may have been defined by broad names, such as “process,” “Java,” “database,” or the like. Thus, previous techniques provided enterprises with little insight into the function of the application service candidate. However, according to the techniques described herein, the identification model 306 may generate an application service candidate name that provides enterprise specific context into the function of the application service candidate.

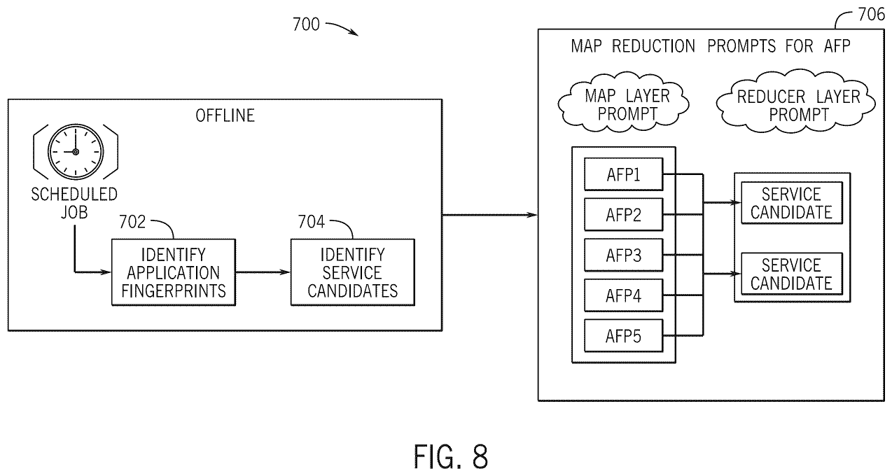

The identification model 306 may also generate a suggested description 506 for the application service candidate. The suggested description 506 may contain plain language insights, such as the function of the application service candidate, its publisher, where it is stored in the online environment (e.g., on a particular server), its update and/or version history, and the like. Further, in some embodiments, the application service candidates may be associated with a domain 508. The domain 508 may refer to subsections or areas of the online environment that the application service candidate is associated with. Some application service candidates may function globally across the online environment. Other application services (e.g., scoped application services) may be associated with a particular function or working group within the online environment. For example, certain application service candidates may be associated with encrypted or sensitive information that is stored in specific data tables or servers. The domain 508 provides an indication as to the location within the online environment that the application service candidate is expected to act. Each application service candidate may also be associated with a checksum 510. As described in more detail with reference to FIG. 8, the checksum 510 may be a unique value that is used to increase efficiency and reduce the amount of computational resources used during preprocessing (e.g., calls to the identification model 306).

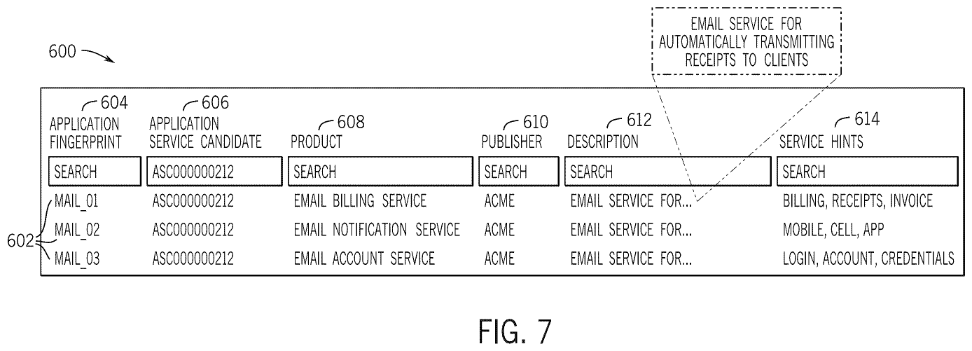

FIG. 7 is an example of a GUI 600 depicting information that the identification model 306 may generate regarding application fingerprints 602. As described in more detail with reference to FIG. 8, the identification model 306 may predict a name for each application fingerprint 602 by analyzing software processes included in the application fingerprint 602. Generative artificial intelligence may be used to extract information from the application fingerprints 602 and generate information about various fields associated with each application fingerprint 602. The application fingerprints 602 may be assigned an identification address 604. The identification address 604 of an application fingerprint 602 may be a unique number or string that may act as a reference for each application fingerprint 602. In some embodiments, the application fingerprints may be associated with an application service candidate 606. In this example, all three application fingerprints have been previously associated (e.g., by the identification model 306) with application candidate number “ASC000000212.”

The identification model 306 may also predict a product name 608 and a publisher 610 for each application fingerprint 602. The product name 608 may be a predicted name for the application fingerprint 602 that the identification model 306 may generate using generative artificial intelligence. Likewise, the publisher 610 may be an enterprise or organization that defines or controls the software processes that make up the application fingerprint 602. In the depicted example, each application fingerprint 602 is associated with the same application candidate 606 and, therefore, has a common publisher 610. Likewise, the identification model 306 may generate a brief description 612 of each application fingerprint 602. The brief description 612 may broadly describe the application fingerprint 602 and provide specific contextual information related to the application fingerprint 602 within the online environment. In some embodiments, as depicted here, the brief description 612 of a particular application fingerprint 602 may be expanded (e.g., by hovering over the entry with a cursor, by selecting it). The application fingerprints 602 may also be associated with service hints 614. Service hints may be keyword or phrase descriptions of the application fingerprints 602.

With the preceding in mind, FIG. 8 is a flow diagram 700 depicting the preprocessing technique for generating information about the application service candidates in the online environment. The identification model 306 may perform preprocessing offline. That is, the preprocessing may occur before a user interacts with a virtual assistant (e.g., the virtual assistant 402 in FIG. 1). The preprocessing may occur in a batch mode, such that the application fingerprints are mapped to a set of application service candidates according to periodic increments. For example, the identification model 306 may be configured to analyze some number (e.g., 50, 100, 150, 200, and so forth) of application service candidates every hour, some number (e.g., 250, 300, 400, 500, 600, 750, and so forth) of application service candidates every day, or the like. In this way, the number of calls to the identification model 306 may be strategically limited to preserve computational and timing resources.

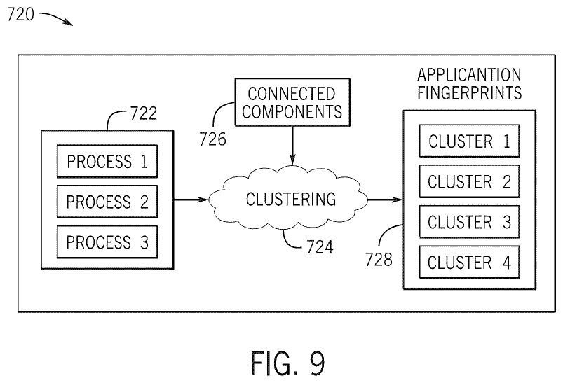

At block 702, the identification model 306 may identify application fingerprints. As mentioned above, application fingerprints may be clusters of associated software processes. The identification model 306 may identify the application fingerprints by predicting a name, publisher, description, and keywords (e.g., as depicted in FIG. 7) that are associated with the application fingerprints. The identification model 306 may do so according to the method described with reference to FIG. 9.

Turning briefly to that figure, FIG. 9 provides a flow diagram 720 illustrating a technique for identifying application fingerprints. In the flow diagram 720, the identification model 306 may first receive software processes 722. The software processes 722 may be collections of data points associated with computer methods or functions. Each application service candidate may be associated with software processes. In some instances, application service candidates may be associated with thousands, tens of thousands, or any number of software processes 722. Certain software processes 722 may be unique to an application service candidate while other software processes may be common across multiple application service candidates. The software processes may be clustered 724 into application fingerprints. For example, in some embodiments, multiple software processes 722 may be grouped together as an application fingerprint 728 based on similar components 726 or features. In some embodiments, unsupervised machine learning techniques may be used for clustering 724 the software processes 722 into application fingerprints 728. Because each application service candidate may have many software processes 722, clustering 724 the processes as fingerprints 728 may help reduce the number of calls to the identification model 306.

Returning to FIG. 8, the offline preprocessing may also include identifying application service candidates 704. A list of application service candidates for a particular online environment may be stored in a data structure (e.g., a data table). For each application service candidate in the data structure, the identification model 306 may generate a predicted name, description, keywords, and the like. The identification model 306 may use a map reduction function 706 to generate the predicted information about each application service based on associating the application service candidates with application fingerprints. During map reduction 706, the identification model 306 may determine that multiple application fingerprints are associated with one application service candidate, and map the multiple application fingerprints to the one application service candidate. The identification model 306 may do so based on the characteristics of the application fingerprints (block 702). For example, the identification model 306 may map multiple application fingerprints to an application service candidate based on machine learning grouping (e.g., unsupervised clustering) of the application fingerprints according to their respective predicted names, descriptions, keywords, publishers, and combinations thereof. In some embodiments, the identification model 306 may also receive alternative information (e.g., user provided information) to facilitate and improve the map reduction process 706. By associating application fingerprints with the application service candidates, the identification model 306 may be able to generate connections between the software processes and the application service candidates according to a reduced number of machine learning calls compared to mapping individual software processes to application service candidates. Accordingly, the identification model 306 may be able to associate software processes to application service candidates with increased computational efficiency.

In some embodiments, additional mapping techniques may be used to further increase computational and timing efficiency. For example, the application service candidates may be assigned checksum values. The checksum values may be used to reduce the likelihood that the same or similar application service candidates are repeatedly processed. Once the identification model 306 generates a name and a description for a particular application service candidate, the identification model 306 may use the checksum value to reduce the risk of re-evaluating the same application service candidate before the identification model 306 processes the other application service candidates in the online environment. However, it should be noted that in some embodiments, the identification model 306 may subsequently reprocess certain application service candidates to capture updates to the online environment.

In embodiments, the information associated with the application fingerprints may be used to generate the information about the application service candidate. Each application service candidate may be associated with a suggested name, a description, keywords, or the like. The application service candidates may be stored in an application service candidate data structure (e.g., an enriched data table) with the suggested names, descriptions, and other identifying information. Thus, a virtual assistant (e.g., the virtual assistant 402 in FIG. 5) may efficiently respond to user queries about the online environment by utilizing the data stored in the application service candidate data structure.

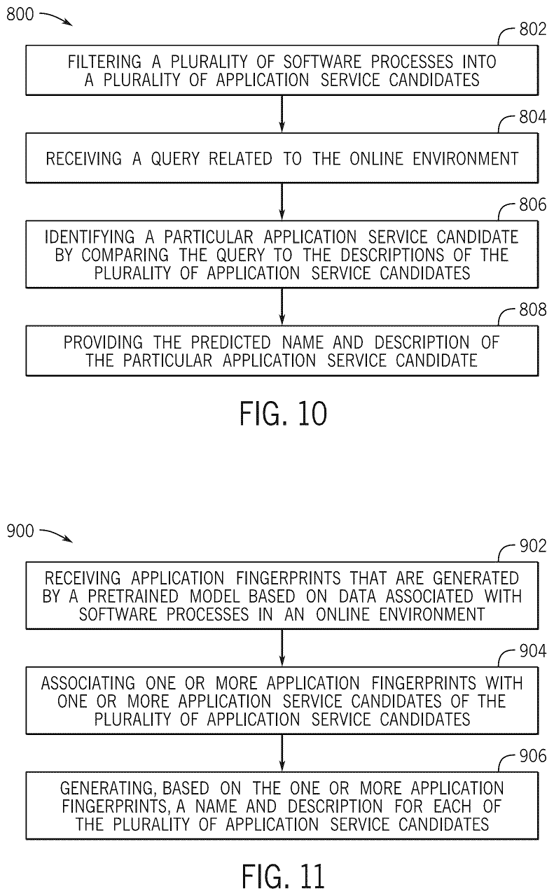

With the preceding in mind, FIG. 10 is a flow chart illustrating a process 800 of generating information about the application service candidates and using that information in conjunction with a virtual assistant. Although the following description of the process 800 is described as being performed by the identification model 306, it should be noted that any suitable device capable of processing data may perform the process 800 described herein. In addition, although the process 800 is described in a particular order, it should be understood that the process 800 may be performed in any suitable order and may exclude one or more of the blocks described herein.

At block 802, the identification model 306 may filter a plurality of software processes into a plurality of application service candidates. The identification model may do so according to the method described with reference to FIG. 11. Indeed, FIG. 11 is a process 900 of filtering software processes in accordance with the techniques described herein.

Turning to FIG. 11, at block 902, the identification model 306 may receive application fingerprints. As mentioned in the preceding description, application fingerprints may be clusters of software processes that the identification model 306 may group using machine learning techniques. In some embodiments, the identification model 306 may request or retrieve predefined application fingerprints from the online environment. In other embodiments, the identification model 306 may receive data associated with software processes in the online environment and generate the application fingerprints. For example, in some embodiments, unsupervised machine learning techniques may be used to generate the application fingerprints. That is, the identification model 306 may cluster unlabeled software processes into application fingerprints.

At block 904, the identification model may associate the application fingerprints with a plurality of application service candidates. As described with respect to FIG. 8, the identification model 306 may use a map reduction function to associate the application fingerprints with application service candidates. By using map reduction, the identification model 306 may reduce the processing power (e.g., the number of machine learning calls) that is required to associate application fingerprints with application service candidates. A data structure may contain the application service candidates that exist in the online environment. The identification model 306 may use machine learning methods (e.g., unsupervised clustering) to map the application fingerprints to a set of the application service candidates in incremental steps. For example, to conserve computational resources, the identification model 306 may be configured to perform periodic preprocessing of the application service candidates by associating the application fingerprints with a set of the application service candidates in the data structure.

At block 906, the identification model 306 may generate a name and description for each application service candidate of the plurality of application service candidates. The identification model may generate the name and the description for each of the plurality of application service candidates based on the associated application service fingerprints (e.g., block 902). The identification model 306 may use the predicted names, description, publishers, and keywords on the application fingerprints to generate application candidate data, including the predicted names and descriptions of the application service candidates. At this block, the identification model 306 may also generate additional application candidate data, such as a publisher, domain, checksum, keywords, and the like. The application service candidate data may be saved and stored in the online environment or in an otherwise accessible location. For example, the data structure containing the application service candidates may be enriched with the application service candidate data generated at this block. Alternatively, the identification model 306 may populate a new or additional data structure with the application service candidate data generated at this block. The application service candidate data may provide advantages over previous techniques that left application service candidates unidentified and/or undescribed. As discussed with reference to FIG. 6, application service candidates may have previously been referred to according to a reference number or a generic name. The systems and methods described herein may result in further insights into the names and functions of the application service candidates, which may promote visibility into the online environment and act as a resource for other processes (e.g., the virtual assistant) acting in the online environment. Moreover, periodic preprocessing may help facilitate user-facing artificial intelligence (e.g., the virtual assistant 402 in FIG. 5) by defining and enriching data sets that the user-facing artificial intelligence may use when responding to queries. Because the identification model 306 may generate application data offline based on batch preprocessing, the user-facing artificial intelligence may quickly respond to client queries related to the application service candidates and their functions within the online environment.

Returning to FIG. 10, at block 804, the identification model 306 may receive a query related to the online environment. The identification model 306 may receive the query through a GUI interaction with a client, a voice-based recording, or the like. The query may be related to the application services and application service candidates in the online environment.

At block 806, the identification model may identify a particular application service of the plurality of application service candidates based on performing a semantic comparison between the query and each of the application service candidates. That is, the identification model 306 may use machine learning technology to respond to the query based on an analysis of the application service candidate data that is stored in the online environment. For example, the identification model 306 may utilize the application service candidate data that is stored in the online environment (block 906 in FIG. 9) and machine learning methodologies (e.g., Retrieval-Augmented Generation (RAG) methods) may be employed to identify the particular application service candidate that is responsive to the query. As mentioned above, the identification model 306 may be a pretrained model that is tailored to the online environment of the client. Thus, the identification model 306 may identify the particular application service candidates based, at least in part, on the client that initiates the query. This may enable the identification model 306 to identify the particular application service candidates that are most relevant to the client.

At block 808, the identification model may provide the predicted name and description of the application service candidate to the client that initiated the query. In some embodiments, the identification model 306 may identify multiple application service candidates that are responsive to the query. For example, as shown in FIG. 5, the identification model 306 may return a list of application service candidates that are responsive to the query. As mentioned with respect to FIG. 5, the client may then use the results provided by the identification model 306 to create and map application services in the online environment. This may allow the client to use the particular application service candidates that the identification model 306 provides to increase the efficiency of future queries and service mapping. For example, the identification model 306 may respond to an additional query by returning previous results (e.g., identified application services) that the client has mapped within the online environment. Further, the identification model 306 may use service mapping associated with the online environment as an input for additional queries. The identification model 306 may, therefore, use the mapped application services to more accurately identify the particular application service candidates or application services that are responsive to the additional queries. In these ways, the identification model 306 may become more accurate within the context of the online environment as it is used.

The disclosed techniques include identifying the application services that are present in an online environment and using machine learning tools to generate useful information about the application services. In a preprocessing step, a pretrained model (e.g., the identification model 306) may receive data from the online environment and automatically classify and categorize the data to determine application identifiers or indicators (e.g., “fingerprints”). The pretrained model may extract information (e.g., names, descriptions, publishers, and keywords) for the application fingerprints. The pretrained model may query a list of the application service candidates that may be incorporated into a specific online environment, and map the application fingerprints to the application service candidates. The pretrained model may use the descriptions of the associated application fingerprints to generate information associated with each application service candidate, such as an application service name, a publisher of the application service, a plain language description of the application service, one or more key word identifiers of the application service, or the like.

In an embodiment, the preprocessing technique for identifying the application service candidates may be used in conjunction with user-facing artificial intelligence technology. For example, the preprocessing technique described herein may be used with an artificial intelligence assistant, such as a text-based or voice-based chat bot that may be trained to respond to user inquiries about the online environment. The user may query the artificial intelligence assistant regarding a question about the online environment (e.g., a question about the application service for a specific function of the online environment), and in response the artificial intelligence assistant may generate and return information (e.g., the predicted names, plain language descriptions) about the relevant application service candidates in the online environment. The user may then select the returned application service candidates to add them as application services, and the selected application services may be mapped within the online environment.

The techniques disclosed herein may provide technical advantages. For example, because of the preprocessing step, which may be performed offline in a batch processing mode, the artificial intelligence assistant may be able to provide temporally efficient results (e.g., real-time results) to user queries about the online environment. Moreover, these techniques may limit the number of computational resources (e.g., processing and memory resources) that may be used to respond to user inquiries about the application services in the online environment. As discussed above, the identification model may be tailored to a specific online environment. The identification model may also use previous responses to queries (e.g., mapped application services) to tailor its responses to additional queries. Thus, the identification model may generate descriptions and provide application service candidates for the specific online environment that it is acting in. These techniques may contribute to a system that enables mapping previously unknown or unidentified application services within the online environment. Thus, users may be provided with insights into their online environments, such as how application services are being used, how application services interact with one another, and the impact of the application services on the online environment. In at least these ways, users may have increased visibility into their online environments.

The specific embodiments described above have been shown by way of example, and it should be understood that these embodiments may be susceptible to various modifications and alternative forms. It should be further understood that the claims are not intended to be limited to the particular forms disclosed, but rather to cover all modifications, equivalents, and alternatives falling within the spirit and scope of this disclosure.

The techniques presented and claimed herein are referenced and applied to material objects and concrete examples of a practical nature that demonstrably improve the present technical field and, as such, are not abstract, intangible or purely theoretical. Further, if any claims appended to the end of this specification contain one or more elements designated as “means for [perform]ing [a function]. . . ” or “step for [perform]ing [a function]. . . ”, it is intended that such elements are to be interpreted under 35 U.S.C. 112(f). However, for any claims containing elements designated in any other manner, it is intended that such elements are not to be interpreted under 35 U.S.C. 112(f).

1. A method comprising:
filtering, via a processing system, a plurality of software processes into a plurality of application service candidates by:
receiving, at the processing system, a plurality of application fingerprints, wherein each application fingerprint of the plurality of application fingerprints comprises a cluster of related software processes in an online environment;
associating, via the processing system, the plurality of application fingerprints with the plurality of application service candidates based on a map reduction function that groups the plurality of application fingerprints into multiple sets of application fingerprints and maps a respective set of application fingerprints to a respective application service candidate of the plurality of application service candidates, wherein each set of application fingerprints comprises one or more related application fingerprints; and
generating, via a pretrained model, a predicted name and plain language description for each respective application service candidate of the plurality of application service candidates based on the respective set of application fingerprints;
receiving, at the processing system, a query related to the online environment;
identifying, via the processing system, a particular application service candidate of the plurality of application service candidates based on a semantic comparison of the query to each respective plain language description of the plurality of application service candidates; and
providing, via the processing system, the predicted name and plain language description of the particular application service candidate.

2. The method of claim 1, wherein the plain language description comprises one or more of: an application service candidate name, a publisher of the application service candidate, and one or more key word identifiers of the application service candidate.

3. The method of claim 2, comprising providing, via the processing system, the predicted name and plain language description of the particular application service candidate to a client device via an artificial intelligence assistant.

4. The method of claim 2, comprising storing, via the processing system, the predicted name and plain language description for the plurality of application service candidates in a data source, wherein the particular application service candidate is identified based on a Retrieval-Augmented Generation (RAG) function, the query, and the data source.

5. The method of claim 1, wherein filtering, via the processing system, the plurality of application fingerprints into the plurality of application service candidates occurs in periodic preprocessing stages, wherein the periodic preprocessing stages comprise generating, via the processing system the predicted names and plain language descriptions for each of the plurality of application service candidates during an offline batch analysis process.

6. (canceled)

7. The method of claim 1, comprising
receiving, at the processing system, an indication to identify the particular application service candidate as an application service in the online environment; and
in response to the indication, updating, via the processing system, a map of the online environment to include the application service.

8. The method of claim 7, wherein updating, via the processing system, the map of the online environment to include the application service comprises updating an application dependency map by generating at least one connection between the application service and at least one additional application service in the online environment.

9. A system comprising:
processing circuitry; and
a memory accessible by the processing circuity, and storing instructions that, when executed by the processing circuitry, cause the processing circuitry to perform operations comprising:
filtering a plurality of software processes into a plurality of application service candidates by:
receiving a plurality of application fingerprints, wherein each application fingerprint of the plurality of application fingerprints comprises a cluster of related software processes in an online environment;
associating the plurality of application fingerprints with the plurality of application service candidates based on a map reduction function that groups the plurality of application fingerprints into multiple sets of application fingerprints and maps a respective set of application fingerprints to a respective application service candidate of the plurality of application service candidates, wherein each set of application fingerprints comprises one or more related application fingerprints; and
generating, via a pretrained model, a predicted name and a plain language description for each respective application service candidate of the plurality of application service candidates based on the respective set of application fingerprints;
receiving a query related to the online environment;
identifying a particular application service candidate of the plurality of application service candidates based on a semantic comparison of the query to each respective plain language description of the plurality of application service candidates; and
providing the predicted name and plain language description of the particular application service candidate.

10. The system of claim 9, wherein the operations comprise:
receiving an indication to identify the particular application service candidate as an application service in the online environment; and
in response to the indication, updating a map of the online environment to include the application service.

11. The system of claim 10, wherein the map is an application dependency map or an enterprise architecture map.

12. The system of claim 9, wherein the operations comprise:
identifying an additional application service candidate of the plurality of application service candidates based on the semantic comparison of the query to each respective plain language description of the plurality of application service candidates; and
providing the predicted name and description of the additional application service candidate.

13. The system of claim 9, wherein providing the predicted name and plain language description of the particular application service candidate comprises transmitting the predicted name and description of the particular application service candidate to a client device.

14. The system of claim 9, wherein the predicted names and plain language descriptions for each of the plurality of application service candidates are generated during an offline batch analysis process.

15. A non-transitory, computer readable medium comprising instructions that, when executed by processing circuitry, cause the processing circuitry to perform operations comprising:
filtering a plurality of software processes into a plurality of application service candidates by:
receiving a plurality of application fingerprints, wherein each application fingerprint of the plurality of application fingerprints comprises a cluster of related software processes in an online environment;
associating the plurality of application fingerprints with the plurality of application service candidates based on a map reduction function that groups the plurality of application fingerprints into multiple sets of application fingerprints and maps a respective set of application fingerprints to a respective application service candidate of the plurality of application service candidates, wherein each set of application fingerprints comprises one or more related application fingerprints; and
generating, via a pretrained model, a predicted name and a plain language description for each respective application service candidate of the plurality of application service candidates based on the respective set of application fingerprints;
receiving a query related to the online environment;
identifying a particular application service candidate of the plurality of application service candidates based on a semantic comparison of the query to each respective plain language description of the plurality of application service candidates; and
providing the predicted name and plain language description of the particular application service candidate.

16. (canceled)

17. The non-transitory computer readable medium of claim 15, wherein the operations comprise:
receiving an indication to identify the particular application service candidate as an application service in the online environment; and
in response to the indication, updating a map of the online environment to include the application service.

18. The non-transitory computer readable medium of claim 15, wherein the plain language description comprises one or more of: an application service candidate name, a publisher of the application service candidate, and one or more key word identifiers of the application service candidate.

19. The non-transitory computer readable medium of claim 15, wherein the application fingerprints are generated by the pretrained model based on unsupervised machine learning clustering of the plurality of software processes.

20. The non-transitory computer readable medium of claim 15, wherein the operations comprise generating a predicted name and description for each of the plurality of application fingerprints.

21. The method of claim 5, comprising:
assigning, via the processing system, a value to each application service candidate of the plurality of application service candidates in response to the pretrained model generating the predicted name and plain language description for each application service candidate of the plurality of application service candidates in a first preprocessing stage;
receiving, at the processing system, an additional plurality of application service candidates; and
filtering, via the processing system, the plurality of software processes into one or more application service candidates of the additional plurality of application service candidates in a second preprocessing stage based on the one or more application service candidates not being assigned the value.

22. The non-transitory computer readable medium of claim 20, wherein the pretrained model groups the plurality of application fingerprints into the multiple sets of application fingerprints based on the predicted name and description for each of the plurality of application fingerprints.
